(19) United States
(12) Patent Application Publication
(10) Pub. No.: US 2020/0030692 A1
(43) Pub. Date: Jan. 30, 2020

(54) GAME CONTROLLER

(71) Applicant: Cheng Uei Precision Industry Co., Ltd., New Taipei City (TW)

(72) Inventors: Hsieh Cheng Chou, New Taipei City (TW); Chi Ming Tseng, New Taipei City (TW)

(21) Appl. No.: 16/174,517

(22) Filed: Oct. 30, 2018

(30) Foreign Application Priority Data
Jul. 30, 2018 (TW) 107210349

(51) Int. Cl. A63F 13/24

(52) U.S. Cl. CPC A63F 13/24

(57) ABSTRACT

The present invention is a game controller. The game controller comprises a body. At least one recess is disposed on a surface of the body, the recess has a side wall. At least one actuating module comprises a base body and an operating portion forming from the base body, the actuating module is removably mounted in the recess. At least one ring is removably positioned around the actuating module. The actuating module is fixed in the recess through a rotation of the ring, the rotation of the ring causing the ring engages with the side wall of the recess.

### CROSS-REFERENCE TO RELATED APPLICATION

The present application is based on, and claims priority from, Taiwan Patent Application No. 107210349, filed Jul. 30, 2018, the disclosure of which is hereby incorporated by reference herein in its entirety.

### BACKGROUND OF THE INVENTION

### 1. Field of the Invention

The present invention generally relates to a game controller, more particularly, the game controller comprises at least one actuation module, the game controller is able to exchange a location of the actuating module to another location of the actuation module.

### 2. The Related Art

At present, most of game controllers are designed to operate with both hands. Some of conventional hand-held game controllers include different actuating modules to provide a user for playing game, such like action button module, directional gamepad module, thumbstick module, trigger module, bumper button module and/or paddle module. Specifically, the action button module, directional gamepad module and thumbstick module are disposed in a top of game controller. The trigger module and the bumper button module are disposed in a front of game controller. And the paddle module is disposed in a bottom of game controller. Each actuating module represents a different game instruction in a game, which makes the game full with diversity.

With the rise of the electronic sport, it also promotes rapidly the gaming market. The game controller has more diversified control function, however, every user has different controlling habit when he operates the game controller. Some people are used to controlling the thumbstick module by their thumb, the other people are used to controlling the directional gamepad module by their thumb. However, most of the actuating modules usually be fixed on the game controller and cannot be moved; therefore, it is not able to meet the user's demand.

### SUMMARY OF THE INVENTION

The present invention is to provide a game controller, the game controller comprises at least one actuating module which can be detachable, a user can replace two different locations of the actuating module.

An object of the present invention provides a game controller. The game controller comprises a body. The recess is disposed on a surface of the body, the recess has a side wall. At least one actuating module comprises a base body and an operating portion forming from the base body, the actuating module is removably mounted in the recess. At least one ring is removably positioned around the actuating module. The actuating module is fixed in the recess through a rotation of the ring, the rotation of the ring causing the ring engages with the side wall of the recess.

### BRIEF DESCRIPTION OF THE DRAWINGS

The present invention will be apparent to those skilled in the art by reading the following description, with reference to the attached drawings, in which:

FIG. 1 is an exploded view of a game controller;

FIG. 2A is a schematic view of a first actuating module;

FIG. 2B is a top plan view of the first actuating module of FIG. 2A;

FIG. 2C is another view of the first actuating module of FIG. 2A;

FIG. 3A is a schematic view of a second actuating module;

FIG. 3B is a top plan view of the second actuating module of FIG. 3A;

FIG. 3C is another view of the second actuating module of FIG. 3A;

FIG. 4A is a schematic view of the game controller of FIG. 1, wherein the first actuating module is mounted in the game controller;

FIG. 4B is an enlarged view of a portion A of FIG. 4A;

FIG. 5A is a schematic view of a first ring of the game controller;

FIG. 5B is another view of the first ring of the game controller of FIG. 5A;

FIG. 6A is a schematic view of a second ring of the game controller;

FIG. 6B is another view of the second ring of the game controller of FIG. 6A;

FIG. 7 is a schematic view that the first ring hitches the first actuating module;

FIG. 8 is a schematic view that the second ring hitches the second actuating module;

FIG. 9A is a portion sectional view of FIG. 7;

FIG. 9B is an enlarged view of a portion B of FIG. 9A;

FIG. 10A is a portion sectional view of FIG. 8;

FIG. 10B is an enlarged view of a portion C of FIG. 10A;

FIG. 11A is a schematic view of the game controller, wherein the first actuating module and the second actuating module are not mounted in the game controller;

FIG. 11B is an enlarged view of a portion D of FIG. 11A;

FIG. 12A is another view of the game controller of the game controller of FIG. 11A;

FIG. 12B is an enlarged view of a portion E of FIG. 12A;

FIG. 13A is a schematic view of the game controller, wherein the actuating modules are mounted in the game controller and the rings are arranged on the actuating modules but the rings are not rotated;

FIG. 13B is an enlarged view of a portion F of FIG. 13A;

FIG. 14A is a schematic view of the game controller, wherein the actuating modules are mounted in the game controller and the rings are engaged with the game controller after being rotated;

FIG. 14B is an enlarged view of a portion G of FIG. 14A;

### DETAILED DESCRIPTION OF THE PREFERRED EMBODIMENT

The following detailed description is merely exemplary in nature and is not intended to limit the applications and uses disclosed herein. Further, there is no intention to be bound by any theory presented in the preceding background or summary or the following detailed description.

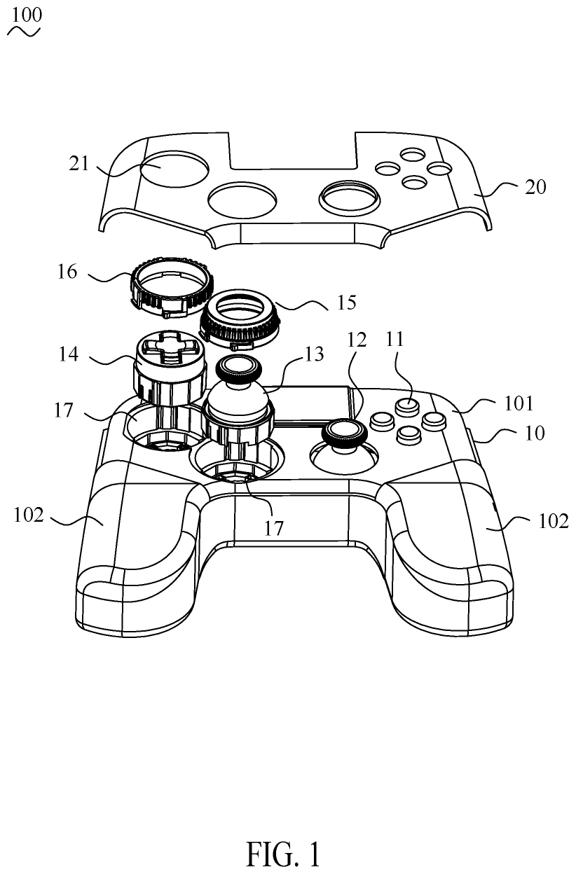

Referring to FIG. 1, a game controller 100 is shown. The game controller 100 includes a body 10, a shell 20 which can detach from the body 10.

The body 10 has a main portion 101 and a hand portion 102 extending from two sides of the main portion 101. The main portion 101 comprises a plurality of actuating modules which connects a circuit module inside the game controller 100. The actuating modules comprise an action button module 11, a thumbstick module 12, a first actuating module 13 and a second actuating module 14. The action button module 11 and the thumbstick module 12 are fixed in the main portion 101 of the game controller 100. The first actuating module 13 and the second actuating module 14 are capable of dismounting from the main portion 101 of the game controller 100. Two recesses 17 are arranged on the main portion 101 which are provided mounting locations for the first actuating module 13 and the second actuating module 14 respectively. The first actuating module 13 can be fixed in the recesses 17 by a first ring 15. The second actuating module 14 can be fixed in the recesses 17 by a second ring 16.

In some embodiment, the fixed actuating modules in the main portion 101 of the game controller 100 is not limited to the action button module 11 or the thumbstick module 12, which can be a directional gamepad module or the same actuating module.

In some embodiment, the first actuating module 13 and the second actuating module 14 may adopt different actuating function such as, e.g. but not limited to an action button, a directional gamepad, a thumb stick or the same actuating function. In the embodiment of the present invention, the first actuating module 13 is a thumbstick module, the second actuating module 14 is a directional gamepad module.

The shell 20 comprises a plurality of apertures 21, each location of the apertures 21 is corresponded to a location of the action button module 11, a location of the thumb stick module 12, a location of the first actuating module 13 and a location of the second actuating module 14 respectively. Specifically, a portion of the first actuating module 13 and a portion of the second actuating module 14 pass through the aperture 21 when the shell 20 is mounted on the body 10.

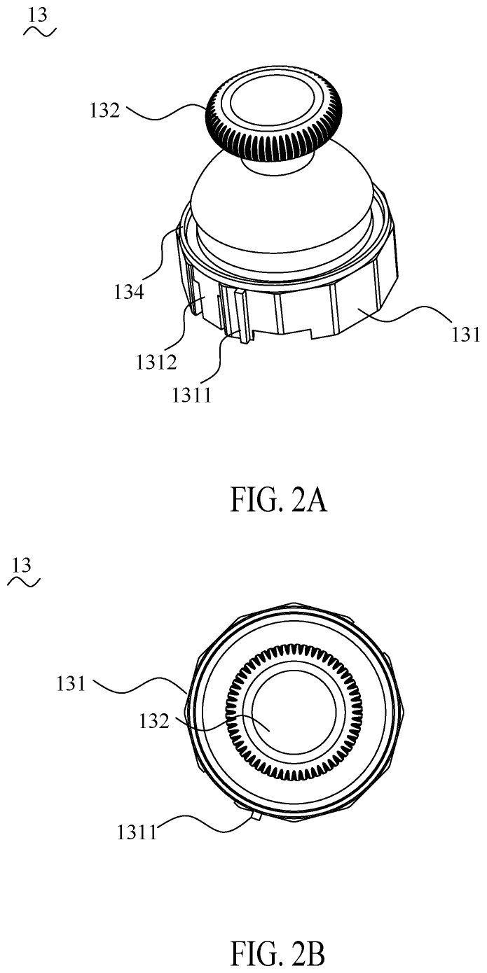

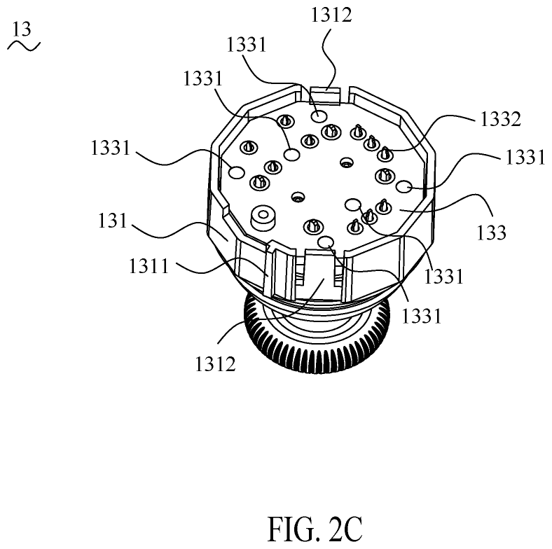

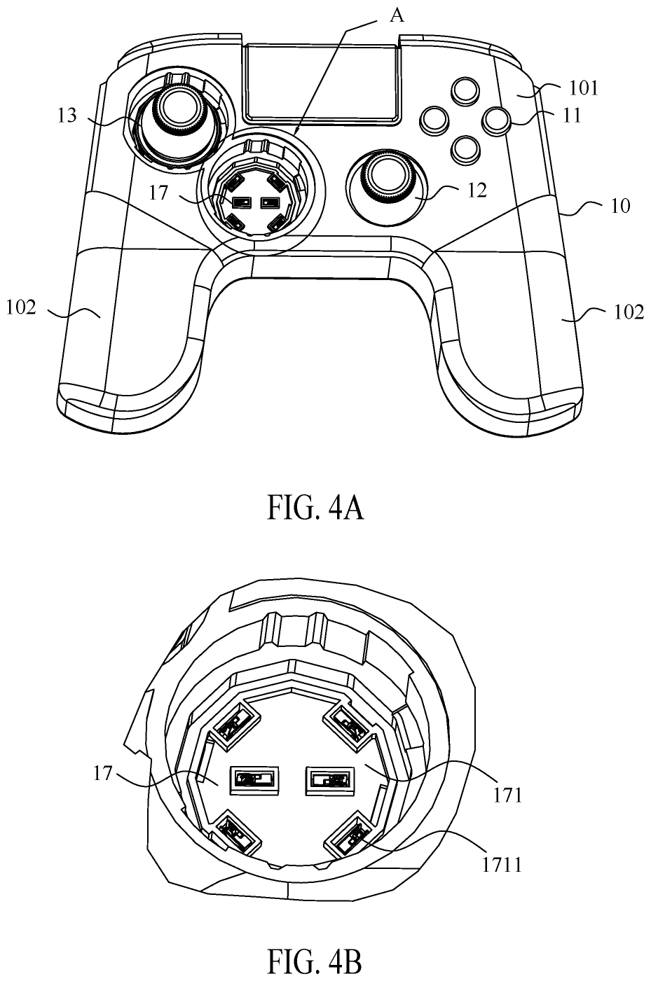

Referring to FIG. 2A to FIG. 2C, and FIG. 4A to FIG. 4B. The first actuating module 13 has a first base body 131 and a first operating portion 132 forming from the first base body 131 thereon. In the present embodiment, the first base body 131 is a dodecagon. One of lateral sides of the first base body 131 has a first rib 1311 rising from the lateral sides of the first base body 131. The periphery of the first base body 131 has two first buckles 1312 with relative location.

In the present embodiment, the first operating portion 132 is a thumbstick module, the thumbstick module forms on the first base body 131 and a circuit module is arranged inside the thumbstick module. The circuit module electrically connects a first connecting area 133 of a bottom of the first base body 131, wherein the first connecting area 133 comprises a plurality of first pins 1331 and a plurality of first welding points 1332 of the circuit module. When the first actuating module 13 is disposed in the recess 17, a user can control first operating portion 132 and a plurality of electric signals are conducted to the first pins 1331 through the circuit module of the thumbstick module, and then the first pins 1331 electrically connects a contacting area 1711 of the recess 17 to conduct the user's instructions for the game controller 100.

A first holding portion 134 is formed in a connection location between the first base body 131 and the first operating portion 132, the first holding portion 134 is configured to hold the first ring 15.

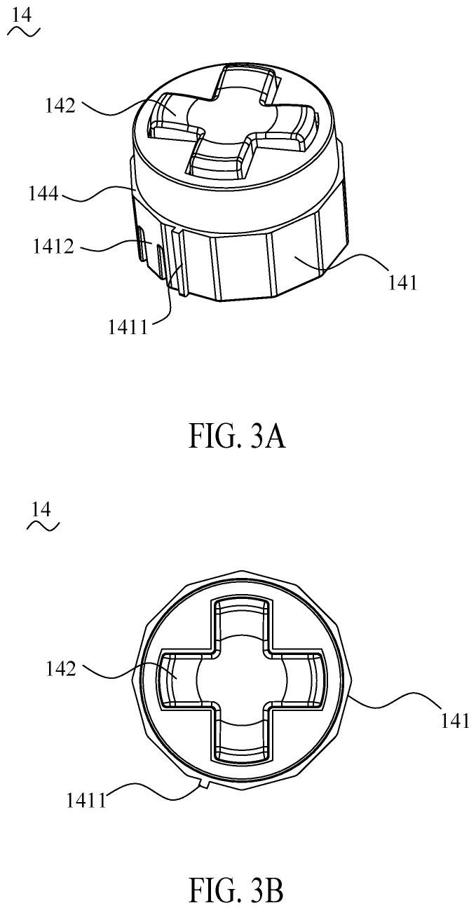

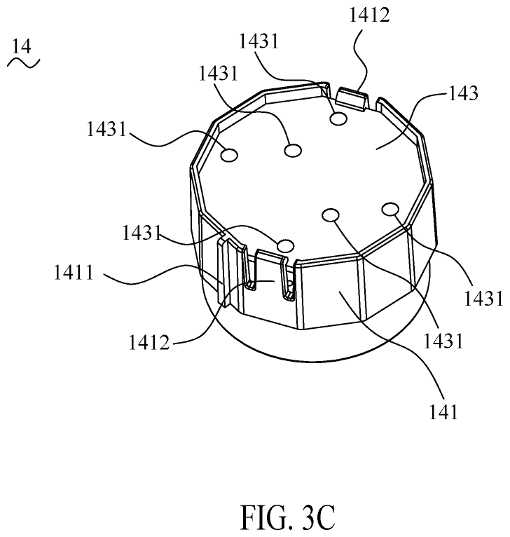

Referring to FIG. 3A to FIG. 3C. The second actuating module 14 has a second base body 141 and a second operating portion 142 forming from the second base body 141 thereon. In the present embodiment, the second base body 141 is a dodecagon. One of lateral sides of the second base body 141 has a second rib 1411 rising from the lateral sides of the second base body 141. The periphery of the second base body 141 has two second buckles 1412 with relative location.

In the present embodiment, the second operating portion 142 is a directional gamepad module, the directional gamepad module forms on the second base body 141 and a circuit module is arranged inside the directional gamepad module. The circuit module electrically connects a second connecting area 143 of a bottom of the second base body 141, wherein the second connecting area 143 comprises a plurality of second pins 1431. When the second actuating module 14 is disposed in the recess 17, the user can control second operating portion 142 and a plurality of electric signals are conducted to the second pins 1431 through the circuit module of the directional gamepad module, and then the second pins 1431 electrically connects the contacting area 1711 of the recess 17 to conduct the user's instructions for the game controller 100.

A second holding portion 144 is formed in a connection location between the second base body 141 and the second operating portion 142, the second holding portion 144 is configured to hold the second ring 16.

In the present embodiment, a location of the first actuating module 13 and a location of the second actuating module 14 can be exchanged each other in the different recess 17 of the game controller 100. Therefore, the first base body 131 and the second base body 141 have the similar structure, for example, a size of the first rib 1311 and a size of the second rib 1411 are the same, and a location of the first rib 1311 of the first base body 131 and a location of the second rib 1411 of the second base body 141 are arranged in the same location thereof respectively. A location of the first buckle 1312 of the first base body 131 and a location of the second buckle 1412 of the second base body 141 are arranged in the same location thereof respectively. A layout of the first pins 1331 of the first base body 131 and a layout of the second pins 1431 of the second base body 141 are the same. The exterior shape of the first base body 131 and the exterior shape of the second base body 141 are the same.

In some embodiment, the exterior shape of the first base body 131 and second base body 141 are a polygon shape.

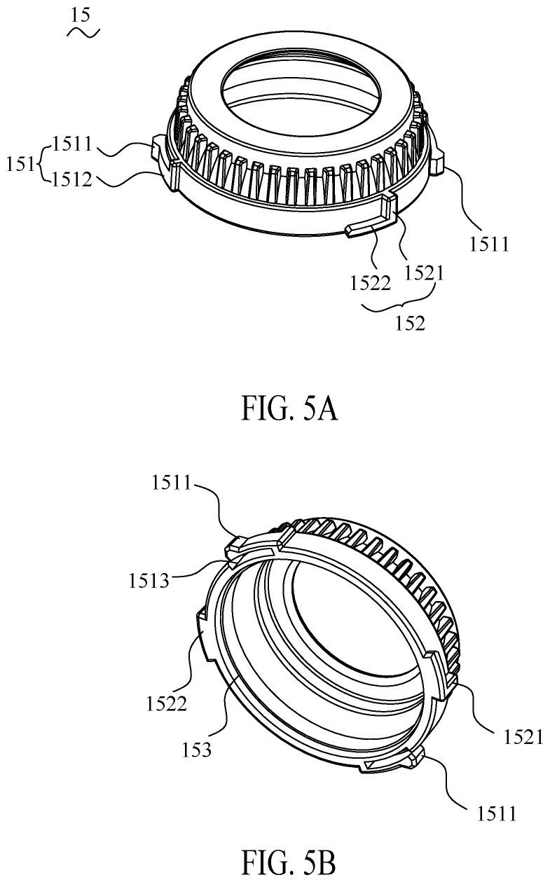

Referring to FIG. 5A to FIG. 5B. A periphery of the first ring 15 comprises two first fixing portions 151 in opposing locations respectively and two first blocking portions 152 in opposing locations respectively. The first fixing portion 151 is a resilient fastener for positioning in the recess 17. The first fixing portion 151 comprises a bump 1511 and a resilient arm 1512 connecting the bump 1511. Specifically, the resilient arm 1512 extends from the periphery of the first ring 15, a hollow area 1513 is formed between the resilient arm 1512 and the periphery of the first ring 15, the bump 1511 extends from a free end of the resilient arm 1512 and protrudes towards outside.

The first blocking portion 152 is a L shape block to fix inside the recess 17. The first blocking portion 152 comprises a head part 1521 and a body part 1522 extending vertically from one end of the head part 1521, an extending direction of the body part 1522 is the same as a connecting direction of the resilient arm 1512 and the bump 1511. Specifically, an extending direction of the head part 1521 is parallel to an axis of the first ring 15, and an extending direction of the body part 1522 extends around the axis of the first ring 15.

A first contacting portion 153 is formed in an inner edge of the first ring 15 for supporting the first actuating module 13, wherein the first contacting portion 153 is a step structure.

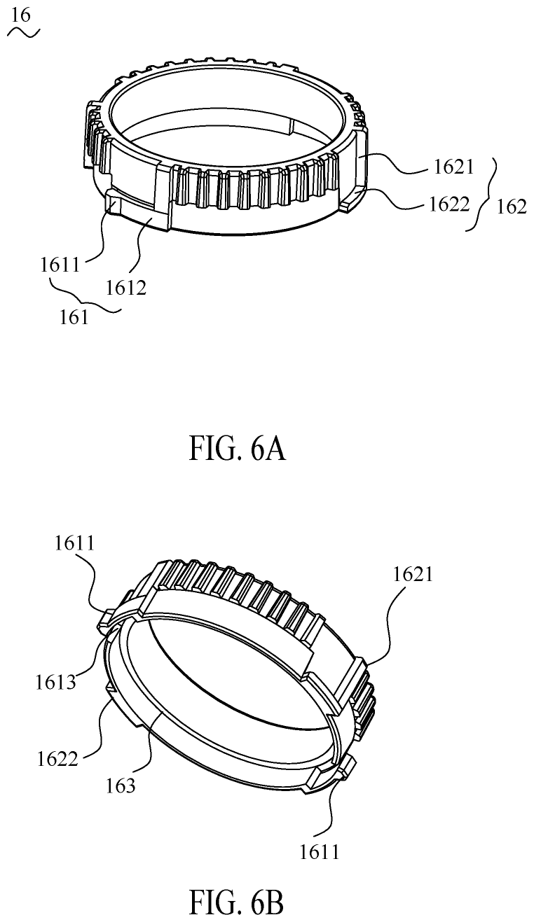

Referring to FIG. 6A to FIG. 6B. A periphery of the second ring 16 comprises two second fixing portions 161 in opposing locations respectively and two second blocking portions 162 in opposing locations respectively. The second fixing portion 161 is a resilient fastener for positioning in the recess 17. The second fixing portion 161 comprises a bump 1611 and a resilient arm 1612 connecting the bump 1611. Specifically, the resilient arm 1612 extends from the periphery of the second ring 16, a hollow area 1613 is formed between the resilient arm 1612 and the periphery of the second ring 16, the bump 1611 extends from a free end of the resilient arm 1612 and protrudes towards outside.

The second blocking portion 162 is a L shape block to fix inside the recess 17. The second blocking portion 162 comprises a head part 1621 and a body part 1622 extending vertically from one end of the head part 1621, an extending direction of the body part 1622 is the same as a connecting direction of the resilient arm 1612 and the bump 1611. Specifically, an extending direction of the head part 1621 is parallel to an axis of the second ring 16, and an extending direction of the body part 1622 extends around the axis of the second ring 16.

A second contacting portion 163 is formed in an inner edge of the second ring 16 for supporting the second actuating module 14, wherein the second contacting portion 163 is a step structure.

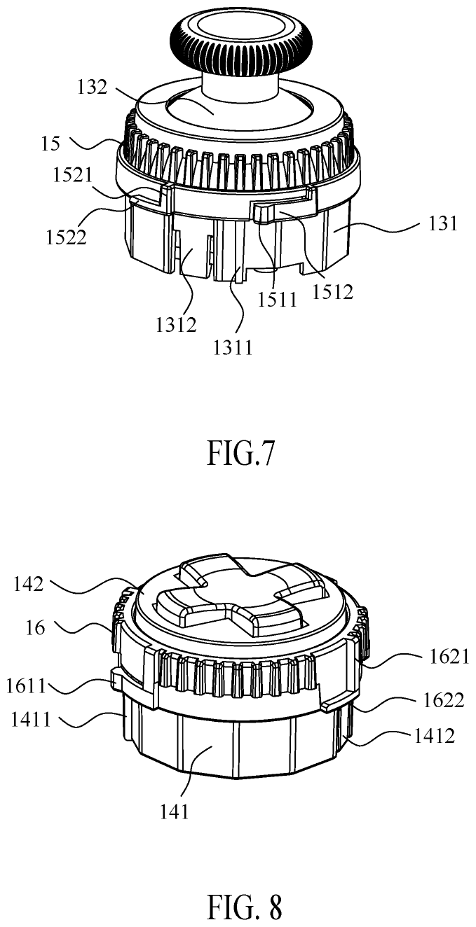

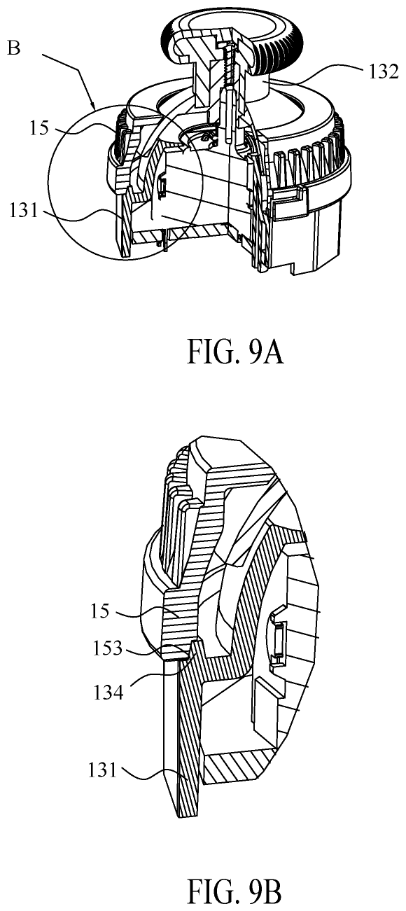

Referring to FIG. 7, FIG. 9A to FIG. 9B. When the first ring 15 is positioned around the first actuating module 13, the first contacting portion 153 is supported by the first holding portion 134. Specifically, both of a touching side of the first contacting portion 153 and a touching side of the first holding portion 134 are inclined plane.

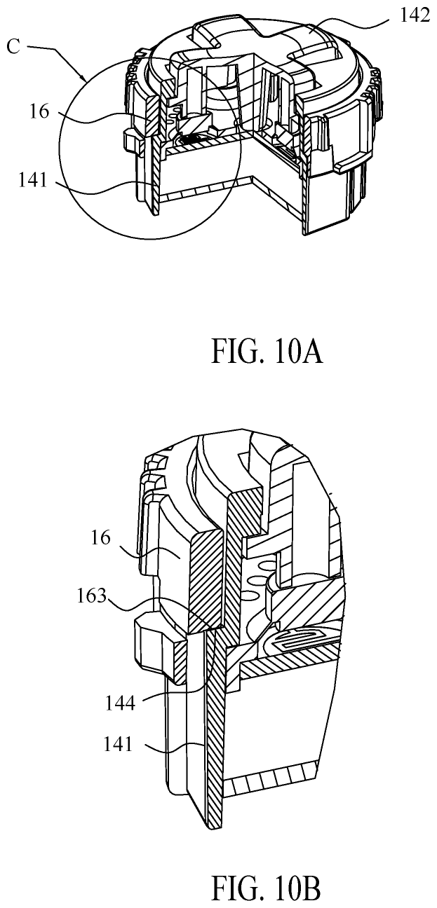

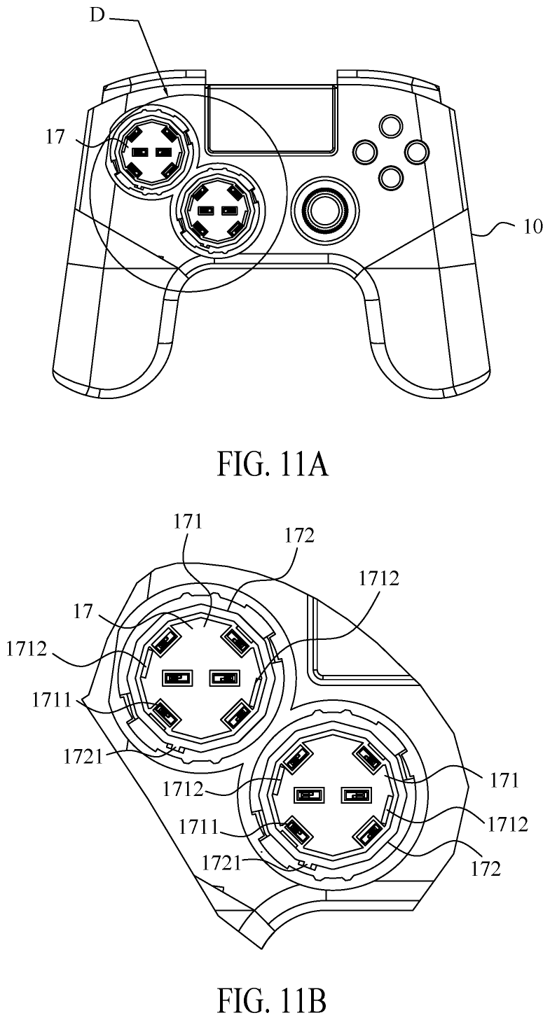

Referring to FIG. 8, FIG. 10A to FIG. 10B. When the second ring 16 is positioned around the second actuating module 14, the second contacting portion 163 is supported by the second holding portion 144. Specifically, both of a touching side of the second contacting portion 163 and a touching side of the second holding portion 144 are horizontal plane.

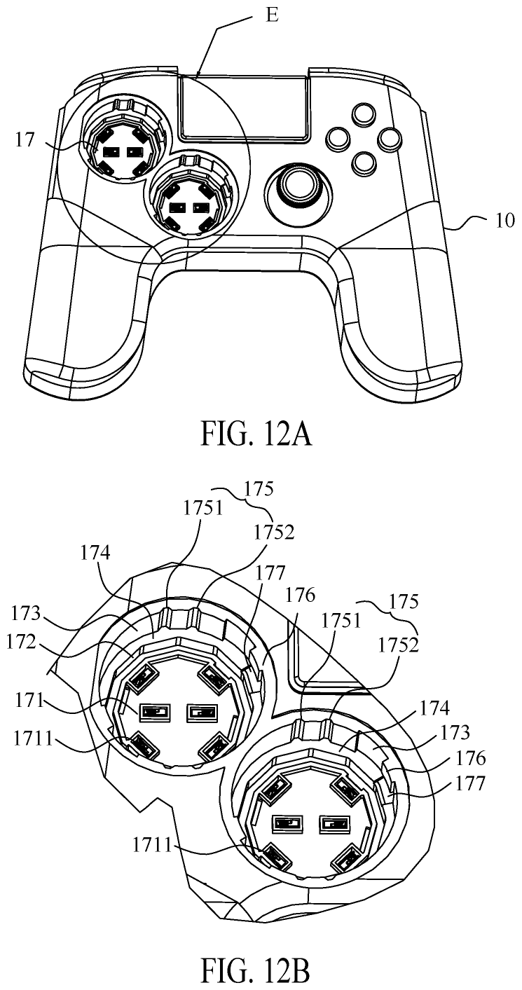

Referring to FIG. 11A to FIG. 12B. the game controller 100 comprises two recesses 17 with the same structure. Each recess 17 has a dodecagon periphery, the recess comprises a bottom 171, a first side wall 172 upward extends from the bottom 171, a second side wall 173 upward extends from the first side wall 172, and a contacting side 174 connects between the first side wall 172 and the second side wall 173.

The bottom 171 comprises the contacting area 1711 and two engaging slots 1712 formed oppositely. A layout of the contacting area 1711 is arranged the sane as the layout of the first pins 1331 and the layout of the second pins 1431. In the present embodiment, the layout of the contacting area 1711 is arranged with a plurality of sheet metal springs for contacting the first pins 1331 and the second pins 1431, but it is not limited to the way of the sheet metal springs, the spring pogo pin is also can be adopted. The engaging slot 1712 is provided a fixing location for the first buckle 1312 or second buckle 1412.

The first side wall 172 comprises a first position portion 1721, the first position portion 1721 is a notch structure forming on the first side wall 172. Specifically, the first rib 1311 of the first actuating module 13 and the second rib 1411 of the second actuating module 14 are able to engage with the first position portion 1721.

The second side wall 173 comprising two second position portions 175 arrange oppositely and two stopping portions 176 arranged oppositely. Each second position portion 175 comprises a first engaging portion 1751 and a second engaging portion 1752, the second position portion 175 is provided as an engaging location for the bump 1511 of the first ring 15 or the bump 1611 of the second ring 16. Each stopping portion 176 is a rise forming in the second side wall 173, and a sliding space 177 is formed between the rise and the contacting side 174. The sliding space 177 is provided a sliding range for the body part 1522 of the first ring 15 or the body part 1622 of the second ring 16.

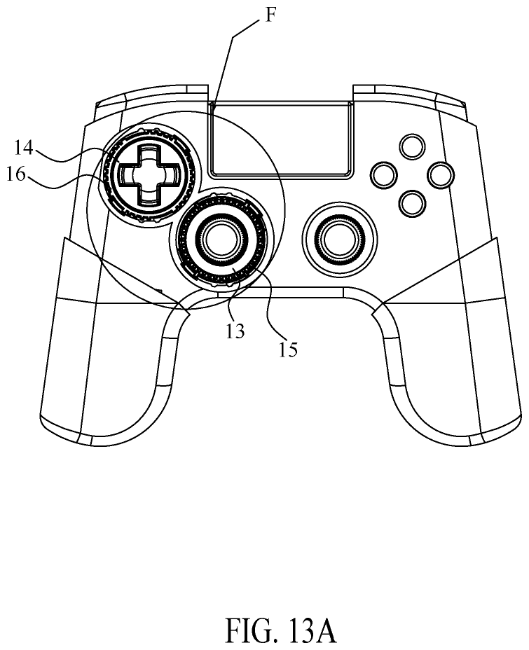

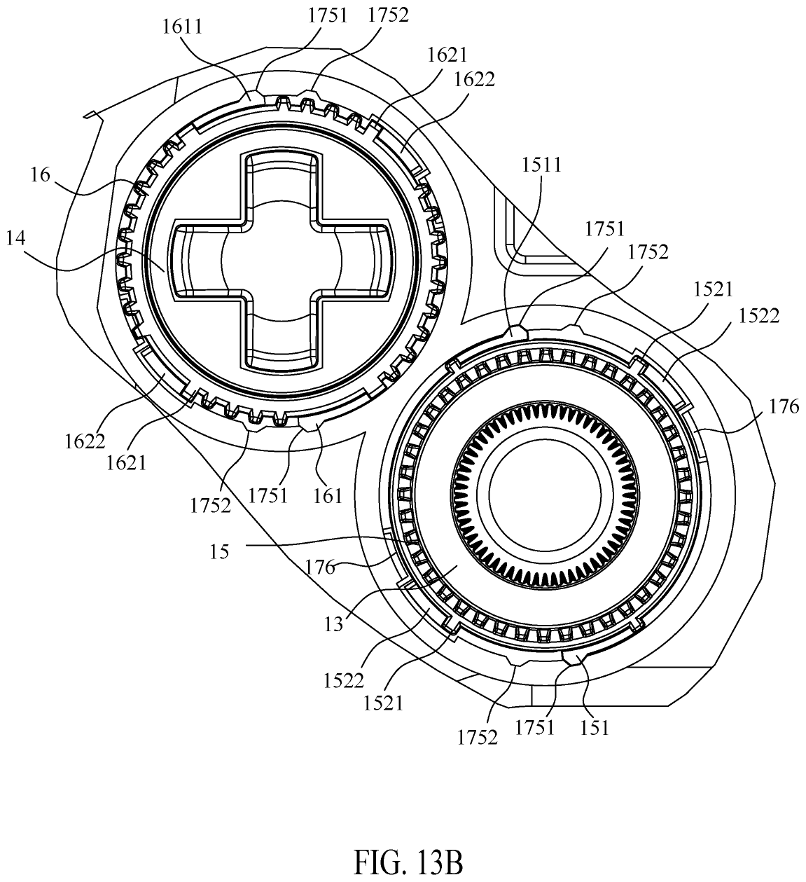

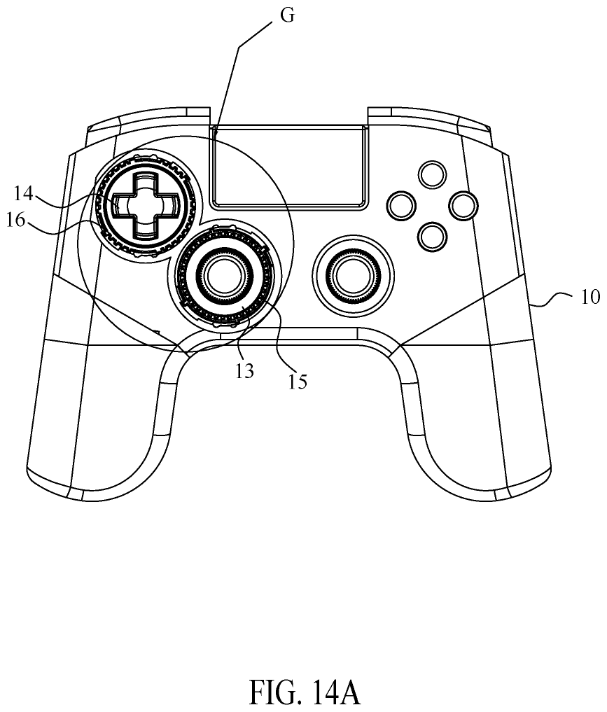

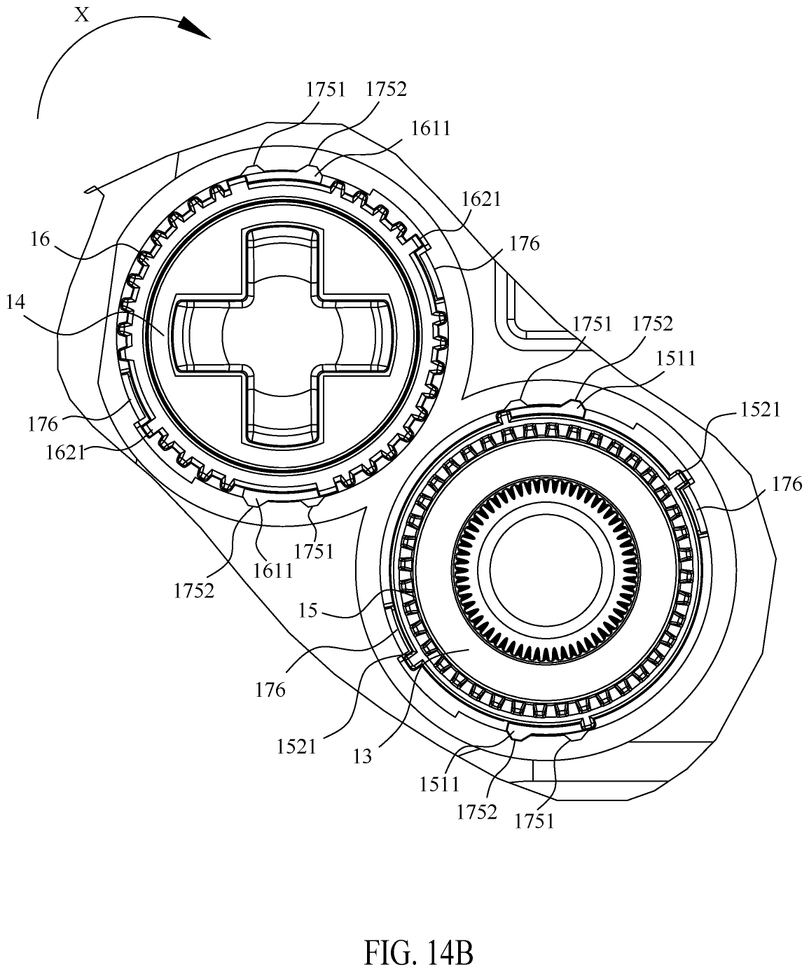

Referring to FIG. 13A to FIG. 14B. In the following description, there are only describing a rotary relationship between the first actuating module 13 and the first ring 15 in the recess 17, but this is equivalent to a rotary relationship between the second actuating module 14 and the second ring 16 in the recess 17.

When the first actuating module 13 is disposed in the recess 17, the first rib 1311 of the first actuating module 13 is positioned and engaged in the first position portion 1721 of the first side wall 172. When the first ring 15 is positioned around the first actuating module 13, the bump 1511 of the first ring 15 is located in the first engaging portion 1751, the first blocking portion 152 has not engaged with the stopping portion 176 yet.

When the first ring 15 is rotated along the clockwise direction of the first ring 15, the bump 1511 of the first ring 15 is rotated to the second engaging portion 1752, and the head part 1521 of the first blocking portion 152 is rotated until blocking by the stopping portion 176, the body part 1522 of the first blocking portion 152 is rotated into the sliding space 177; therefore, the first blocking portion 152 is engaged with the stopping portion 176.

As described above, the present invention provides the game controller 100 that a user can choose the location of the first actuating module 13 and the location of the second actuating module 14 according to user's preference, and the first ring 15 and the second ring 16 are able to fix stably the first actuating module 13 and the second actuating module 14 in the game controller 100.

What is claimed is:

1. A game controller, comprising:
a body;
at least one recess disposed on a surface of the body, the recess having a side wall;
at least one actuating module comprising a base body and an operating portion forming from the base body, the actuating module removably mounted in the recess;
at least one ring removably positioned around the actuating module;
wherein the actuating module is fixed in the recess through a rotation of the ring, the rotation of the ring causing the ring engages with the side wall of the recess.

2. The game controller as claimed in claim 1, wherein an exterior shape of the base body is a polygon.

3. The game controller as claimed in claim 1, wherein the side wall comprises a first side wall and a second side wall, a contacting side connects between the first side wall and the second side wall, the first side wall has a first positioning portion, the second side wall has a second positioning portion.

4. The game controller as claimed in claim 3, wherein the base body comprises a rib, the first positioning portion is a notch, the rib is configured to engage with the notch.

5. The game controller as claimed in claim 3, wherein the ring comprises a fixing portion, the second positioning portion comprises a first engaging portion and a second engaging portion, the fixing portion is configured to engage with the first engaging portion or the second engaging portion according to a location of the rotation of the ring.

6. The game controller as claimed in claim 5, wherein the fixing portion has a resilient arm, one end of the resilient arm connects to the ring, the other end of the resilient arm connects to a bump, the bump is configured to engage with the first engaging portion or the second engaging portion according to the location of the rotation of the ring.

7. The game controller as claimed in claim 3, wherein the ring comprises a blocking portion, and the second side wall comprises a stopping portion, the stopping portion is configured to block the blocking portion.

8. The game controller as claimed in claim 7, wherein the stopping portion is a rise forming on the second side wall, and a sliding space is formed between the rise and the contacting side.

9. The game controller as claimed in claim 8, wherein the blocking portion comprises a head part and a body part extending from one end of the head part, the head part is configured to block the stopping portion, the body part is configured to slide into the sliding space.

10. The game controller as claimed in claim 1, wherein an outer edge of the base body of the actuating module comprises a holding portion, and an inner edge of the ring comprises a contacting portion, the holding portion is configured to be supported by the contacting portion.

11. A game controller, comprising:
a body;
at least one recesses disposed on the body, the recess having a side wall;
at least one actuating module comprising a base body and an operating portion forming from the base body, the actuating module removably mounted in the recess;
at least one ring removably positioned around the actuating module, the ring having a fixing portion;
wherein the actuating module is fixed in the recess through a movement of the ring, the movement of the ring causing the fixing portion engages with the side wall of the recess.

12. The game controller as claimed in claim 11, wherein an exterior shape of the base body is a polygon.

13. The game controller as claimed in claim 11, wherein the side wall comprises a first side wall and a second side wall, a contacting side connects between the first side wall and the second side wall, the first side wall has a first positioning portion, the second side wall has a second positioning portion.

14. The game controller as claimed in claim 13, wherein the base body comprises a rib, the first positioning portion is a notch, the rib is configured to engage with the notch.

15. The game controller as claimed in claim 13, wherein the second positioning portion comprises a first engaging portion and a second engaging portion, the fixing portion is configured to engage with the first engaging portion or the second engaging portion according to a location of the movement of the ring.

16. The game controller as claimed in claim 15, wherein the fixing portion has a resilient arm, one end of the resilient arm connects to the ring, the other end of the resilient arm connects to a bump, the bump is configured to engage with the first engaging portion or the second engaging portion according to the movement of the ring.

17. The game controller as claimed in claim 13, wherein the ring comprises a blocking portion, and the second side wall comprises a stopping portion, the stopping portion is configured to block the blocking portion.

18. The game controller as claimed in claim 17, wherein the stopping portion is a rise forming on the second side wall, and a sliding space is formed between the rise and the contacting side.

19. The game controller as claimed in claim 18, wherein the blocking portion comprises a head part and a body part extending from one end of the head part, the head part is configured to block the stopping portion, the body part is configured to slide into the sliding space.

20. The game controller as claimed in claim 11, wherein an outer edge of the base body of the actuating module comprises a holding portion, and an inner edge of the ring comprises a contacting portion, the holding portion is configured to be supported by the contacting portion.
